(19) United States
(12) Patent Application Publication
(10) Pub. No.: US 2007/0258234 A1
(43) Pub. Date: Nov. 8, 2007

(54) Decorative wall light fixtures or sconces fed by an electric battery

(76) Inventor: Vernon Shaw-Jones, Durham, NC (US)

Correspondence Address: VERNON SHAW-JONES, 1527 BIDWELL STREET, PITTSBURGH, PA, 15233, US

(21) Appl. No.: 11/790,699

(22) Filed: Apr. 26, 2007

Related U.S. Application Data
(60) Provisional application No. 60/797,004, filed on May 1, 2006.

(51) Int. Cl. F21L 4/00

(52) U.S. Cl. 362/157

(57) ABSTRACT

The invention relates to a decorative wall light fixtures or sconces which includes a two part structure (1) which includes a front plate a hollow generally translucent bowl that has pegs mounted on the inside upper edge of said member (2) which includes a back plate that has notches which is on the upper edge of the said back plate which holds the translucent bowl, a single-cell or multi-cell battery, a said light bulb and said switch means being provided for switching the light bulb on and off in accordance with the invention

The present invention relates to a decorative wall light fixtures or sconces fed by an electric battery and more in particular to a sconce which will provide a soft lighting effect both indirect and accent lighting Wall lighting fixtures or sconces have been provided in the past that creates a variety of different lighting effects One particularly popular effect is a light fixture which produces upwardly directed indirect lighting while also providing a luminous surface directed outwardly and downwardly to produce accent lighting In such fixtures the majority of the light is the indirect lighting directed upwardly and/or towards the wall and ceiling produced from a single light source A secondary fluorescent light source located, for example, on the opposite side of an individual reflector from the principal light source provides illumination for a surrounding translucent bowl or decorative housing to produce the desired accent lighting. Such lighting fixtures have proven to be highly popular for both their functional and aesthetic features However, because such fixtures require 110 volts or higher one or two light sources, not to mention electrician and carpenter to install wall fixture or to those skilled in the art They are relatively expensive to manufacture and to maintain It is an object of the present invention to provide a decorative wall lighting fixture or sconce that will produce both indirect and accent lighting from a single light source. Another object of the present invention is to provide a decorative light fixture which is relatively simple to manufacture and inexpensive to construct. Another object of the present invention is to provide a decorative wall sconce, which produces both indirect and accent lighting that is relatively inexpensive to manufacture while retaining the appearance of an expensive wall fixture The above and other objects, features and advantages of this invention will be apparent in the following detailed description of an illustrative embodiment thereof, which is to be read in connection with the accompanying drawings wherein:

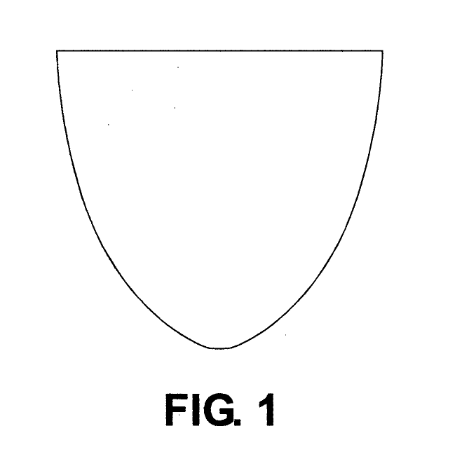

FIG. 1 is a perspective view of a decorative wall sconce fixture constructed in accordance with the present invention;

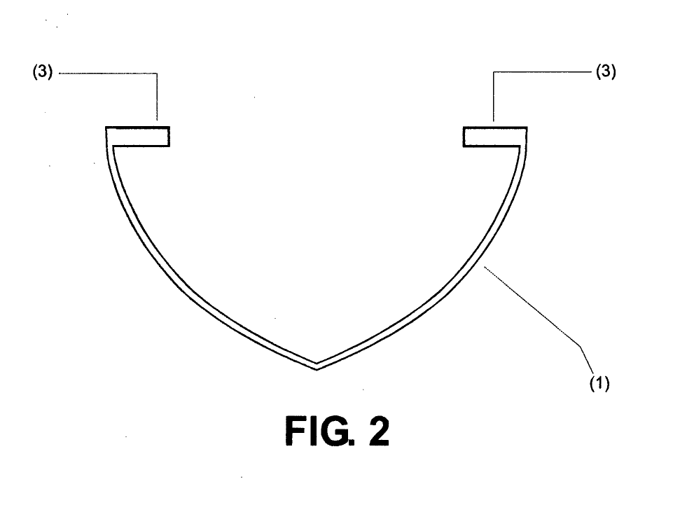

FIG. 2 is a view of front plate of a wall sconce fixture of FIG. 1;

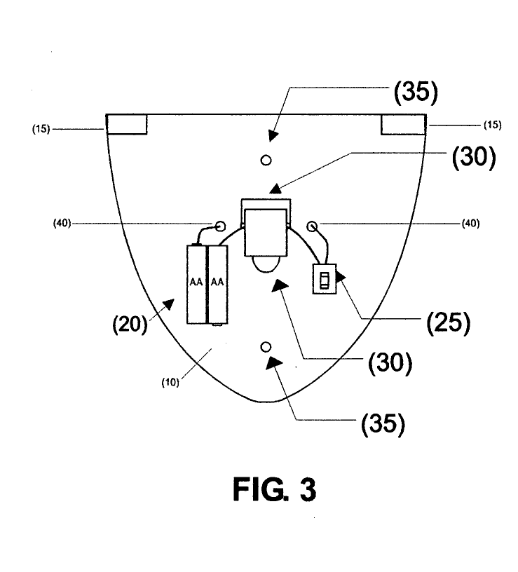

FIG. 3 is a view of back plate of the wall sconce of FIG. 1;

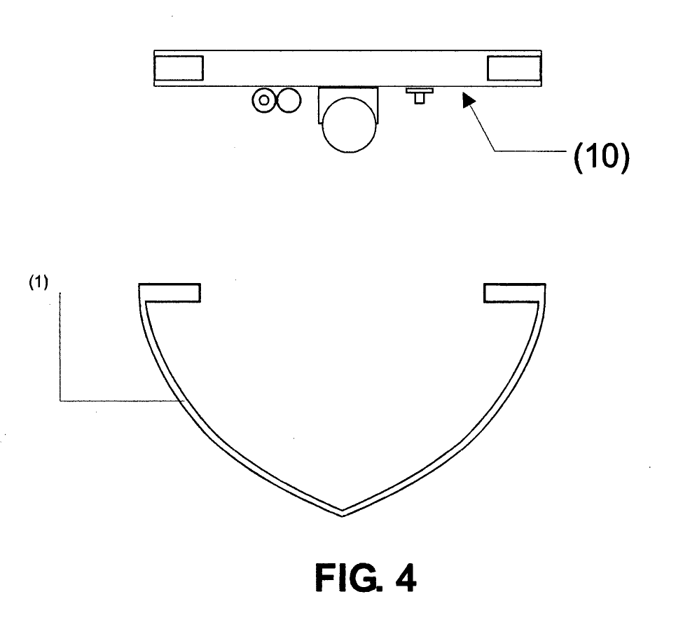

FIG. 4 is a view of top front plate and back plate of the wall sconce of FIG. 1;

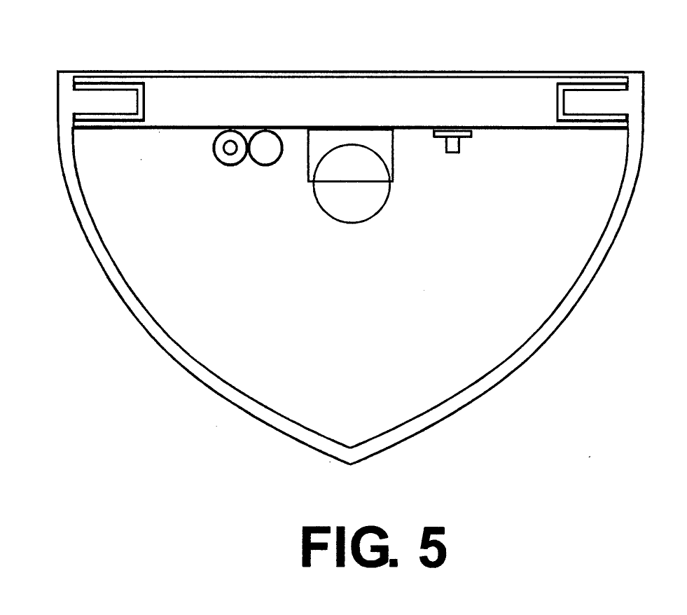

FIG. 5 is a view of front and back plate join together of the wall sconce of FIG. 4;

Referring now to the drawings in detail, and initially to FIG. 1, a decorative wall sconce constructed in accordance with the present invention is illustrated The sconce includes, a wall mounting back plate (10) FIG. 3 and a front plate member (1) FIG. 2 that provides the soft accent lighting in the fixture as described hereinafter. In an illustrative embodiment of the invention, the front plate (1) FIG. 2 is generally one-half spherical bowl in shape The bowl is a hollow member formed of blown polyethylene resin, or the like, preferably in a translucent white color, although other translucent colors can be used as desired As seen in FIG. 2, the bowl is a one-piece structure includes pegs mounted on inside upper edge (3) of bowl that sits in notches (15) in FIG. 3 The back plate (10) FIG. 3 is a generally flat member formed of blown polyethylene resin, or the like The wall member is adapted to be mounted in a fixed position on a wall (35) in any convenient manner such as, for example, screws or the like, as would be apparent to those skilled in the art The plate has an opening (40) formed therein to allow electrical wire or the like, to pass through for the connection of the said battery (20) and the said switch (25) The switching means can be of the push-button type, pivoting type or the like. An said light bulb and said light bulb housing (30) fixed on the center surface of said wall plate (10) pointing downward of the transparent bowl so that the said bowl reflects light upwardly and/or towards the wall and ceiling illuminating the entire surface on said bowl The said light bulb and said light bulb housing sit between said battery (20) and said switch (25) The said light bulb housing is mounted on said back plate by a nut and bolt, or the like The battery compartment contains a multi-cell battery which bears a pair of electrical contacts mounted in the battery compartment and conductively connected to the said light bulb and said switch a pair of electrical contacts mounted in the said switch and conductively connected to the said light bulb and said battery compartment. Although an illustrative embodiment of the invention has been described herein with reference to the accompanying drawings, it is to be understood that this invention is not limited to that precise embodiment and that various changes and modifications may be effected therein by those skilled in the art without departing from the scope or spirit of this invention.

I claim:

1. A battery-operated decorative wall light fixtures or sconces comprising:
A two part structure a said front plate a hollow generally translucent bowl member that has pegs mounted on the inside upper edge of said member of substantially one-half of a bowl shape, a said back plate support that has notches which is on the upper edge of the said back plate which holds the translucent bowl member, a said battery means for a source of power, a said light bulb which is mounted in a said light bulb housing pointing downward of the transparent bowl so that the bowl reflects light upwardly within it to provide an entirely luminous surface on the bowl and a said switch means being provided for switching the light bulb on and off in accordance with the invention

2. A decorative wall light fixtures or sconces comprising a said wall mounting back plate as defined in claim 1: a housing having a said battery compartment molded on said back plate of wall light fixtures or sconces for a source of power a said light bulb LED or the like, a said light bulb housing mounted on said support means on the opposite side thereof from the said battery compartment a said switch mounted on said support means on the opposite side thereof from the said light bulb a pair of electrical contacts mounted in the said battery compartment and conductively connected to the said light bulb and said switch a pair of electrical contacts mounted in the said switch and conductively connected to the said light bulb and said battery compartment
